(19) United States
(12) Patent Application Publication
(10) Pub. No.: US 2022/0092561 A1
(43) Pub. Date: Mar. 24, 2022

(54) METHOD AND DEVICE FOR CONTROLLING A CRYPTOCURRENCY

(71) Applicant: Robert Bosch GmbH, Stuttgart (DE)

(72) Inventors: Alexander Poddey, Wiernsheim (DE); Ricky Lamberty, Stuttgart (DE)

(21) Appl. No.: 17/446,901

(22) Filed: Sep. 3, 2021

(30) Foreign Application Priority Data
Sep. 23, 2020 (DE) 102020211937.6

(51) Int. Cl. G06Q 20/06; G06Q 20/38; G06Q 30/08

(52) U.S. Cl. CPC G06Q 20/065; G06Q 30/08; G06Q 20/3827; G06Q 20/38215

(57) ABSTRACT

A method for controlling a cryptocurrency based on a bonding curve predefined for a rate of the cryptocurrency. In the method, in a commercial transaction involving the cryptocurrency, a shift of the curve to be applied is calculated based on a previous course of the rate. The curve is integrated and the rate for the commercial transaction is set based on the curve and on a predefined bid-ask spread. The course is updated. Effects of the commercial transaction on the rate are established and taken into account.

### CROSS REFERENCE

The present application claims the benefit under 35 U.S.C. § 119 of German Patent Application No. DE 102020211937.6 filed on Sep. 23, 2020, which is expressly incorporated herein by reference in its entirety.

### FIELD

The present invention relates to a method for controlling a cryptocurrency. The present invention also relates to a corresponding device, to a corresponding computer program as well as to a corresponding machine-readable memory medium.

### BACKGROUND INFORMATION

Any protocol in computer networks that initiates a consensus with respect to the sequence of particular transactions is referred to as a decentralized transaction system, a transaction database or a distributed ledger. One common form of such a system is based on a blockchain and forms the basis of numerous so-called cryptocurrencies.

Advanced cryptocurrencies make use of a mechanism known as “curved bonding,” according to which a function referred to as bonding curve is algorithmically defined, which influences the price of units (tokens) of the currency as a function of its current assets. The bonding curve is implemented for this purpose within the scope of an intelligent contract (smart contract), which defines, in particular, the purchase price during the coining (minting) of a token and thus defines (in technical terminology “sets”) a buying rate of the cryptocurrency.

A computer-implemented method for managing a cryptocurrency with “curved bonding” is described in PCT Patent Application No. WO 2019/043668 A1. For this purpose, a plurality of users are provided with an in-market wallet suitable for storing linked digital tokens, which are linked in value to cryptocurrency tokens and are required to be transacted on a digital marketplace platform. A cryptocurrency reserve is provided for storing cryptocurrency tokens. When a user purchases linked digital tokens in a marketplace store, the linked digital tokens are transferred to the in-marketplace wallet and the equivalent value in the form of cryptocurrency tokens is transferred to the cryptocurrency reserve. Responsive to a user withdrawing a number of linked digital tokens from the in-marketplace wallet, the desired number of linked digital tokens are removed from the user's in-marketplace wallet and an equivalent value in the form of cryptocurrency tokens is transferred from the cryptocurrency reserve to an out-of-marketplace wallet of the user for storing cryptocurrency tokens outside of the marketplace platform.

U.S. Patent Application Publication No. US 2020/0167512 A1 describes a framework for simulating the operation of a blockchain system. The simulation may result in quantitative practical estimates of how the variation of the bonding curve or other aspects of the system design affects its performance, cost, and/or other metrics of interest. This is to enable designers and operators to use the data produced from one test or model in another, and to optimize the parameters or the protocol of the system relative to one or more target functions.

U.S. Patent Application Publication No. US 2020/0104835 A1 describes a method for assisting transactions that include preferably an intermediary, who maintains an orderbook and is specified as the buyer in all orders in the orderbook. The method includes matching buy and sell orders into a single indivisible batch order, price adjusting for the bid-ask spread and transferring the gain from the spread to the second order in the orderbook.

A generalization of bonding curves, which is intended to simplify the study of the effects of adaptations of the function process based on so-called configuration spaces, is described by ZARGHAM, Michael; SHORISH, Jamsheed; PARUCH, Krzysztof, “From Curved Bonding to Configuration Spaces,” 2019.

One alternative to “curved bonding” for reducing volatility and stabilizing cryptocurrencies is discussed in SHIBANO, Kyohei; LIN, Ruxin; MOGI, Gento, “Volatility Reducing Effect by Introducing a Price Stabilization Agent on Cryptocurrencies Trading,” in: Proceedings of the 2020 The 2nd International Conference on Blockchain Technology. 2020. pp. 85-89.

Arbitrage and pricing on the cryptocurrency market are investigated in MAKAROV, Igor; SCHOAR, Antoinette, “Trading and arbitrage in cryptocurrency markets,” Journal of Financial Economics, 2020, Vol. 135, No. 2, pp. 293-319.

### SUMMARY

The present invention provides a method for controlling a cryptocurrency, a corresponding device, a corresponding computer program as well as a corresponding memory medium.

An example embodiment according to the present invention is based on the finding that the size of an appropriate bid-ask spread changes over time. In this regard, the bid-ask spread should be as minimal as possible on the one hand since it creates additional costs for the regular investor. On the other hand, it should be large enough to prevent moderate pump-and-dump or front-running attacks. Moreover, a broader pump-and-dump attack—in connection with which the attacker causes a price hike so that due to the price movement others buy in the hope of a further increase, whereupon the attacker in turn immediately sells off its tokens—may not always be prevented by a spread appropriate for regular trading.

Based on these insights, an example embodiment of the present invention is provided for automatically adapting the bid-ask spread, which is oriented to the dynamics of the system and, for example, is based on a differential equation. In cases in which the automated market maker, which sets the rate for individual commercial transactions based on the bonding curve and the predefined bid-ask spread, is implemented directly within the chain, the complexity of the calculation proves to be decisive. Moreover, decentralized transaction systems operate de facto in discrete time steps, which in the case of a blockchain, for example, correspond to the joining of a single block. However, these intervals could sometimes be insufficient for integrating a differential equation within the chain in a numerically stable manner or for carrying out other extensive numerical calculations. Furthermore, after a non-trading phase, i.e., after a longer time span, in which no purchase or sale takes place—which is followed by an order, either the relevant equation would have to be solved within the scope of just this order and the necessary operating means (gas) would have to be provided or the part of the contract that solves the equation would have to be regularly executed. For this reason, the explicit solution of complex equations within the chain is potentially not practicable.

Against this background, one advantage of the method described below is a dynamic adaptation of the bid-ask spread using limited operating means.

Advantageous refinements of and improvements on the basic features of the present invention are possible with the measures described herein.

### BRIEF DESCRIPTION OF THE DRAWINGS

Exemplary embodiments of the present invention are represented in the figures and explained in greater detail below.

FIG. 1 shows a first bonding curve.

FIG. 2 shows a second bonding curve.

FIG. 3 shows a third bonding curve.

FIG. 4 shows the graph of an exponential function.

FIG. 5 shows the flowchart of a method according to one first specific embodiment of the present invention.

FIG. 6 schematically shows a server according to one second specific embodiment of the present invention.

### DETAILED DESCRIPTION OF EXAMPLE EMBODIMENTS

FIG. 1 illustrates a simple—here, sigmoid—bonding curve in the form of a dashed line. This has been supplemented by one further curve respectively for bid-ask rate 8. For the sake of simplicity, uniform curves have been used in the present case; in general, any rate 8 may follow a different curve.

The two curves are shifted at the “operating point” defined by present circulation volume 7 and marked on the dashed line by the amount ΔP_{b} and ΔPₛ with respect to the initial curve.

The effective value, for example, for ΔP_{b} is made up of a variable and a fixed portion, the latter ensuring a minimum price range:

ΔP_{b}ΔP_{b,var}+ΔP_{b,min} Formula 1

ΔPₛ=ΔP_{s,var}+ΔP_{s,min} Formula 2

Thus, the following is applicable for bid-ask spread ΔP

ΔPₘᵢₙ=ΔP_{b,min}+ΔP_{s,min} Formula 3

and

ΔP=ΔP_{b}+ΔPₛ. Formula 4

In one general formulation, a greatest possible spread would typically be applied.

Individual portions ΔP_{b} and ΔPₛ may be concordantly selected, however, this is generally not required.

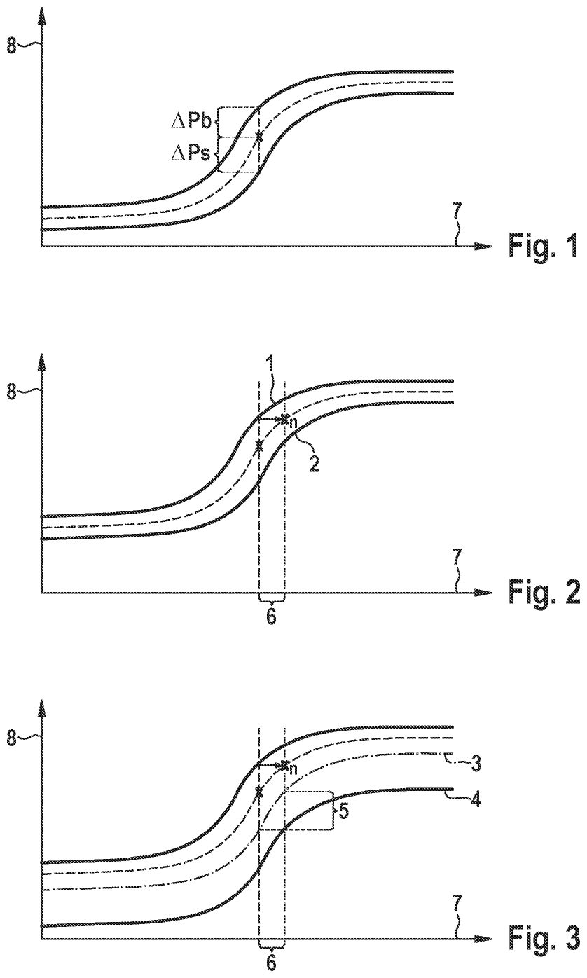

It is now assumed that a purchase with a particular volume (6-FIG. 2) is ordered. As usual, the function underlying the bonding curve for the buying rate (substituted hereinafter by “the curve” for short) would be integrated via interval [X,Xₙ], in order to set the rate 8. This would accordingly be the procedure in the case of a sell order with the selling rate and its bonding curve.

Xₙ in this case marks the new operating point after the ordered commercial transaction.

In order to map the dynamics of the bid-ask spread, a dynamic shift ΔP_{s,var,add} of the curve of the selling rate is introduced according to the present invention. Dot-dashed curve 3 in FIG. 3 corresponds to the original selling rate prior to the commercial transaction. Solid line 4 refers to the actually shifted curve. Shift 5 is given as ΔP_{s,var,add}−ΔP_{s,var,sub}.

ΔP_{s,var,add} could be selected in such a way that the (selling) rate 8 set according to shifted curve 4 in point Xₙ coincides with (selling) rate 8 set according to original curve 3 in point X, as illustrated in FIG. 3. (In the case of ΔP_{s,var,add}=0 a fixed bid-ask spread would result. In deviation thereof, Δ P_{s,var,add} could be defined as an arbitrary other function of rate 8 before or after the commercial transaction or of its volume 6. This also includes, for example, a disproportionate increase of ΔP_{s,var,add} for large trade volumes.

This approach, which may be readily applied to the buying rate, relates to the first aspect of an appropriate dynamic of the bid-ask spread, namely the increase of the spread during brisk trading and high volumes. A second aspect relates meanwhile to the convergence of the bid-ask spread toward its predefined minimum in the absence of trading, which in the overall view makes it possible to adequately achieve a bid-ask spread as a function of the trading volume.

For this purpose, the subtractive component ΔP_{s,var,sub} is introduced, which reduces the bid-ask spread.

The equations for the points in time n and n+1 determined—for example, by blocks—result under the assumption that the individual portions have already been allocated in ΔP_{s,var,n} at point in time n as follows:

ΔP_{s,n}=ΔP_{s,var,n}+ΔP_{s,min}. Formula 5

The additive component for increasing the bid-ask spread as presented above and the subtractive component explained below are now calculated in such a way that the following applies:

ΔP_{s,n+1}=ΔP_{s,var,n}+ΔP_{s,var,add,n+1}−ΔP_{s,var,sub,n+1}+ΔP_{s,min} Formula 6

with

ΔP_{s,var,n+1}=ΔP_{s,var,n}+ΔP_{s,var,add,n+1}−ΔP_{s,var,sub,n+1}. Formula 7

Subtractive component ΔP_{s,var,sub,n+1} may in general be a linear, logarithmic, exponential or other function of the instantaneous and previous shift ΔPₛ. It corresponds preferably to a discretized decay function for ΔPₛ. A larger bid-ask spread should result, for example, in a quantitatively larger subtractive component, the subtractive component decreasing, the closer ΔPₛ approximates ΔP_{s,min}. ΔP_{s,var,sub} could, for example, be an arbitrary function of ΔPₛ, ΔPₛ+ΔP_{b} or of its previous course. It is selected in such a way that it may be easily calculated in the blockchain, even after the elapse of M time steps with no trade volume.

One approach for illustrating this would be the use of an exponential decay function of the following form:

$${Δ P}_{s , var , sub , n + j} = {Δ P}_{s , var , Last} \cdot {e}^{- \frac{j}{T}} \qquad Formula 8$$

with

ΔP_{s,var,Last}=ΔP_{s,var,n}, Formula 9

j referring to the number of ΔPₛ time steps elapsed prior to the update.

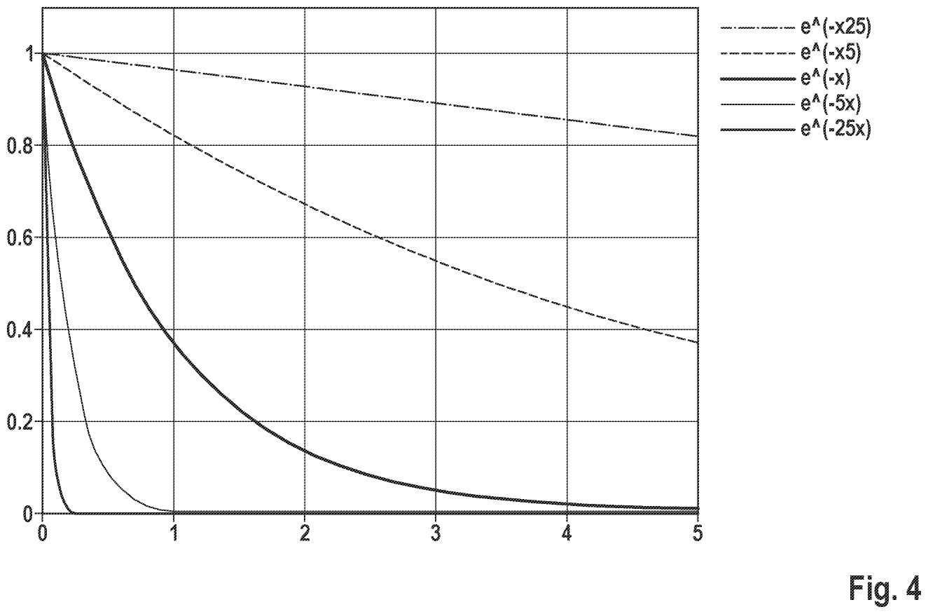

FIG. 4 illustrates the controllability of the exponential function, with the time steps and block steps being plotted on the right axis.

This is one example of an approach in which—regardless of the number of elapsed time steps without an update of ΔPₛ—a single function call is necessary for determining the result.

Note that, in principle, any arbitrary functional form could be used. Polynomial or other functions able to be easily calculated are recommended for a calculation within the blockchain.

ΔP_{s,var,Last} thus relates to ΔP_{s,var} at that time step at which ΔPₛ has most recently been updated. If an update is necessary—implementation-dependent, for example, with each commercial transaction or only with a purchase or sales transaction—ΔP_{s,var,Last} is updated accordingly, at step k, for example, according to

ΔP_{s,var,Last}=ΔP_{s,var,k}.

It is noted once again that exponential decay represents merely one exemplary option without loss of generality.

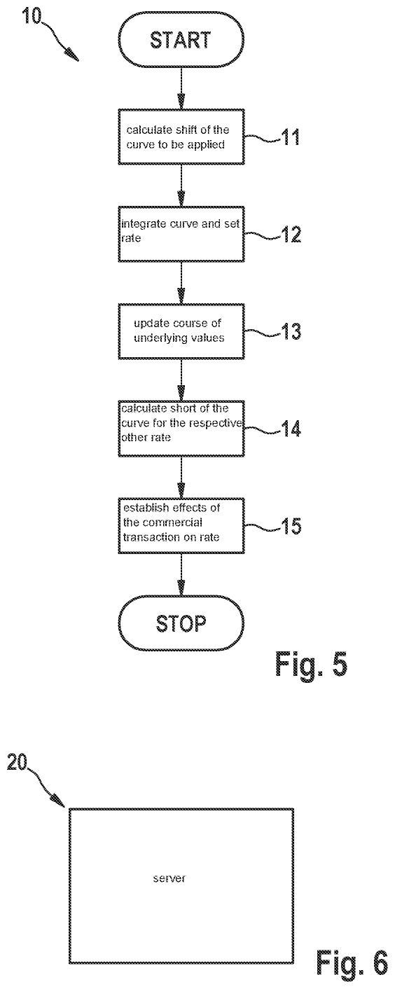

Method 10 represented in its entirety in FIG. 5 may thus be summarized as follows:
1. in a commercial transaction involving the cryptocurrency—even after multiple non-trading time steps—a shift of the curve to be applied is calculated based on a previous course of rate 8 (process 11),
2. the curve is integrated and rate 8 for the commercial transaction is set as usual based on the curve and on a predefined bid-ask spread (process 12),
3. the course of the underlying values is updated (process 13),
4. the shift of the curve for the respective other rate—i.e., for example, of the selling rate in a sale transaction transacted at the buying rate—is calculated (process 14) if the embodiment provides that updates of one of the rates triggers the update of the respective other rate, and
5. effects of the commercial transaction on the rate 8 are established and taken into account (process 15).

This results ultimately in a numerically and, in terms of cost, efficiently calculatable, dynamic bid-ask spread, whose properties are able to be parameterized and the parameters are even able to be dynamically adapted. The parameters and functions could, for example, be selected in terms of the physical interpretability as approximations of a spring-mass system.

Method 10 may, for example, be implemented in software or in hardware or in a mixture of software and hardware, for example, in a server 20, as illustrated in the schematic representation of FIG. 6.

What is claimed is:

1. A method for controlling a cryptocurrency based on a bonding curve predefined for a rate of the cryptocurrency, the method comprising the following steps:
in a commercial transaction involving the cryptocurrency, calculating a shift of a curve to be applied based on a previous course of the rate;
integrating the curve and setting the rate for the commercial transaction based on the curve and on a predefined bid-ask spread;
updating the course; and
establishing and taking into account effects of the commercial transaction on the rate.

2. The method as recited in claim 1, wherein the rate is a buying rate, and after setting the buying rate, the shift of the curve is calculated for a selling rate.

3. The method as recited in claim 1, wherein the rate is a selling rate, and after setting the selling rate, the shift of the curve is calculated for the buying rate.

4. The method as recited in claim 1, wherein:
the shift includes an additive component, and
the shift includes a subtractive component.

5. The method as recited in claim 4, wherein the additive component is selected in such a way that the rate set according to an original curve prior to the commercial transaction coincides with the rate set according to the shifted curve after the commercial transaction.

6. The method as recited in claim 4, wherein:
the additive component is a function of a volume of the commercial transaction, or
the additive component is a function of the rate prior to the commercial transaction, or
the additive component is a function of the rate after the commercial transaction.

7. The method as recited in claim 4, wherein the subtractive component is selected in such a way that a bid-ask spread at a low trading volume converges toward the predefined bid-ask spread.

8. The method as recited in claim 1, wherein a type of the shift or the contributions incorporated into the shift are configured in such a way that an efficient calculation is possible, even in larger time steps or after an elapse of multiple time steps for which no recalculation has taken place.

9. A non-transitory machine-readable memory medium on which is stored a computer program for controlling a cryptocurrency based on a bonding curve predefined for a rate of the cryptocurrency, the computer program, when executed by a computer, causing the computer to perform the following steps:
in a commercial transaction involving the cryptocurrency, calculating a shift of a curve to be applied based on a previous course of the rate;
integrating the curve and setting the rate for the commercial transaction based on the curve and on a predefined bid-ask spread;
updating the course; and
establishing and taking into account effects of the commercial transaction on the rate.

10. A device configured to control a cryptocurrency based on a bonding curve predefined for a rate of the cryptocurrency, the device configured to:
in a commercial transaction involving the cryptocurrency, calculate a shift of a curve to be applied based on a previous course of the rate;
integrate the curve and setting the rate for the commercial transaction based on the curve and on a predefined bid-ask spread;
update the course; and
establish and take into account effects of the commercial transaction on the rate.
